(19) United States
(12) Patent Application Publication
(10) Pub. No.: US 2009/0198784 A1
(43) Pub. Date: Aug. 6, 2009

(54) METHOD FOR AUTOMATICALLY REMINDING USERS OF UPCOMING EVENTS

(76) Inventor: Anna-Karin Bergius, Rosendal (SE)

Correspondence Address: FASTH LAW OFFICES (ROLF FASTH), 26 PINECREST PLAZA, SUITE 2, SOUTHERN PINES, NC, 28387-4301, US

(21) Appl. No.: 12/304,540

(22) PCT Filed: May 9, 2007
(86) PCT No.: PCT/US07/68525

§ 371 Date: Dec. 12, 2008

Related U.S. Application Data
(60) Provisional application No. 60/805,686, filed on Jun. 23, 2006.

(51) Int. Cl. G06F 15/16; G06F 17/30

(52) U.S. Cl. 709/206

(57) ABSTRACT

The method is for reminding a user of an upcoming event. A mobile communication device is provided that is in communication with a server. An event is programmed in a calendar that is stored in the communication device. A picture is associated with the event to describe the event. A clock device of the communication device is used to trigger the event. The picture is automatically retrieved from the communication device and displaying on the device. A user of the communication device is requested to confirm that the event has been accomplished.

### TECHNICAL FIELD

The method relates to a method for automatically reminding users, especially cognitive deficient individuals, of upcoming events.

### BACKGROUND OF INVENTION

The lack of a sufficient short-term memory may be a problem for many of us particularly for cognitive deficient individuals. Cognitive deficient individuals often need more reminders and feedback to make sure they fulfill the duties of everyday chores such as taking medicine and showing up for meetings on time. There is a need for a system that helps cognitive deficient individuals to better function in their everyday lives. There is also a need for a system that provides support for the cognitive deficient individual.

### SUMMARY OF INVENTION

The method of the present invention provides a solution to the above-outlined problems. More particularly, the method is for reminding a user of an upcoming event. A mobile communication device is provided that is in communication with a server. An event is programmed in a calendar that is stored in the communication device. A picture is associated with the event to describe the event. A clock device of the communication device is used to trigger the event. The picture is automatically retrieved from the communication device and displaying on the device. A user of the communication device is requested to confirm that the event has been accomplished.

### BRIEF DESCRIPTION OF DRAWINGS

FIG. 1 is a schematic view of the system of the present invention;

FIG. 2A is a schematic view of a calendar of the present invention;

FIG. 2B is a schematic view of a display for selecting a time of the day;

FIG. 2C is a schematic view of a display and a menu for function selection;

FIG. 3 is a schematic view of a calendar with scheduled events;

FIG. 4 is a schematic view of the display with the reminder function selected;

FIG. 5 is a schematic view of the display with the checklist function selected;

FIG. 6 is a schematic view of the display with the free text function selected;

FIG. 7 is a schematic view of an organization using the present invention;

FIG. 8 shows examples of suitable pictures that reminder the user of upcoming events; and

FIG. 9 shows an example of a picture of an event displayed in the mobile telephone.

### DETAILED DESCRIPTION

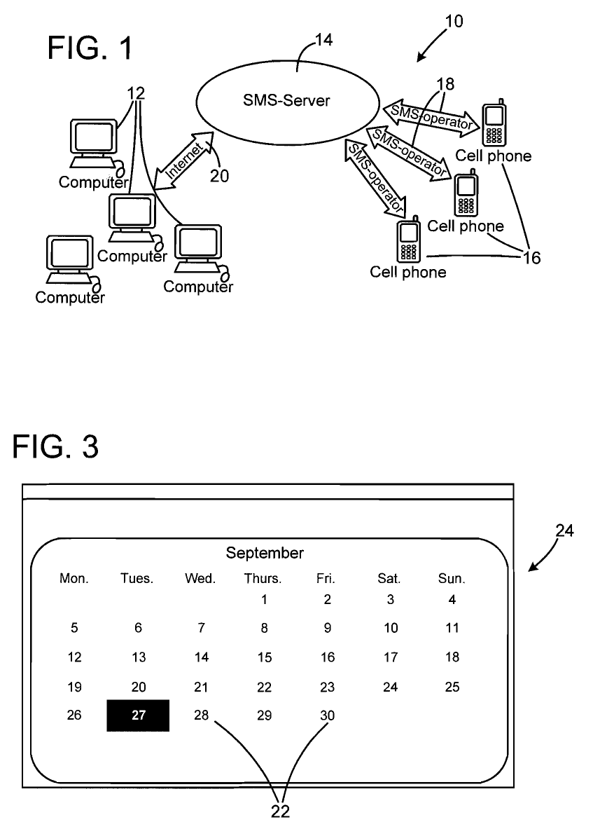

With reference to FIGS. 1-9, the system 10 of the present invention has a computer system 12 that is connected to one or many message servers 14, such as SMS servers, via the Internet 20. Preferably, the server 14 is in communication with a plurality of mobile communication devices 16, such as mobile telephones, via SMS operators 18.

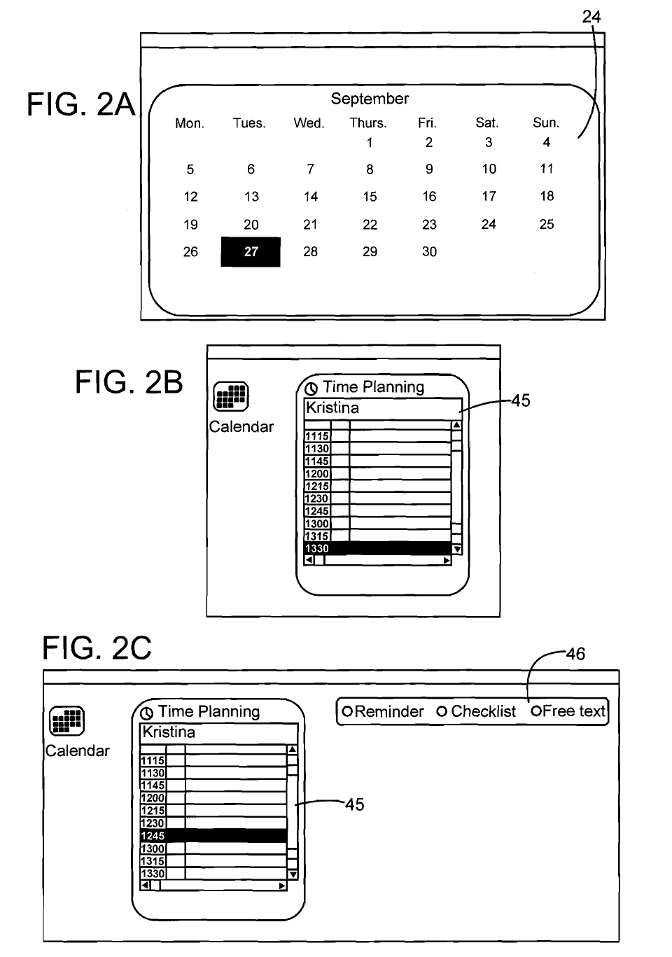

As best shown in FIGS. 2A-2C and described in more detail below, the user or a supervisor may activate the system by first selecting a day in a calendar 24, as shown in FIG. 2A, then selecting a time of the day from a display 45, as shown in FIG. 2B. Finally, a function of a menu 46 is selected, as shown in FIG. 2C.

As best shown in FIG. 3, events 22 are added to the calendar 24, stored in a mobile telephone 16, for which a user 26 needs to be reminded about. The calendar may show an asterisk for each date that includes an event. All the events and other information in the calendar may be sent to the telephone 16 from the server 14 as SMS signals.

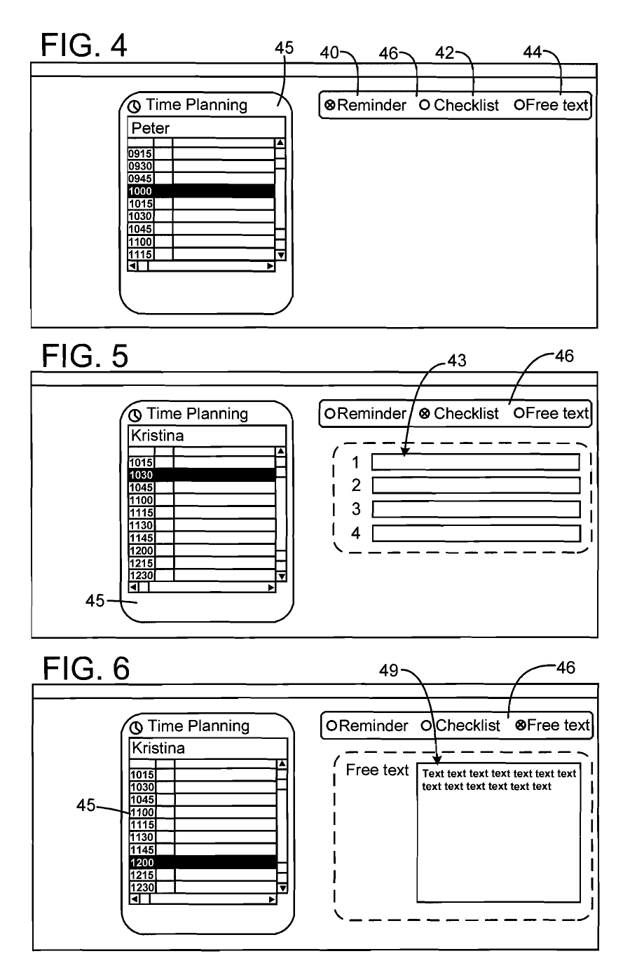

The calendar 24 includes at least three functions namely a reminder function, checklist function and a free-text function. When the reminder function is selected in a menu 46, as best shown in FIG. 4, the user may select a date on the calendar 24 to display the reminder function. When a checklist function 42 is selected, a checklist 43 is displayed, as best shown in FIG. 5. The checklist may be used to list a plurality of events when, for example, there are several events on the same date. When a free text function 44 is selected a free text box 49 is displayed, as best shown in FIG. 6.

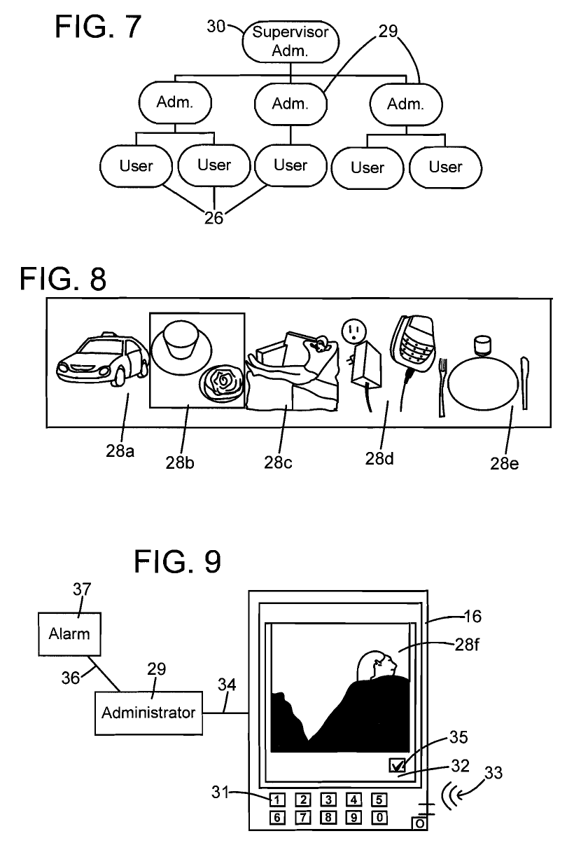

Users 26, administrators 29 or a supervisory administrator 30, as shown in FIG. 7, may add the events to the calendar. It is to be understood that the user 26 may be any user whether the user has a cognitive deficiency or not. However, when the user 26 is cognitive deficient, it may not be effective to use conventional text reminders. To make it easier for the user 26 to understand the event, a picture 28, such as one of the pictures 28a-28e shown in FIG. 8, is associated with the event and shown to the user when the event is due.

When a due date and time of the event 22 is coming up, as determined by a clock and date of the mobile telephone 16, a sound signal 33 may be triggered while, for example, the picture 28f, as shown in FIG. 9, appears in a display 32 of the telephone 16. The picture 28 may be a picture of the person the user is going to meet or a picture of the medicine bottle so the user knows which medicine the user needs to take. New pictures may also be taken with a digital camera that is then stored in the telephone 16. In this way, the pictures are customized and depict a more exact copy of the surrounding of the user. The pictures should be selected so that the user easily realizes what the event is about and what the user needs to do. Of course, it may also be possible to use text messages if necessary. As an example of the connection between the picture and the event, FIG. 28f automatically shows a person sleeping, which is activated or triggered to be the shown on the telephone display to instruct the user that it is time to take a nap. There is no need for the user to manually retrieve the picture because it is automatically triggered to be shown on time by the program/system of the telephone 16. Preferably, the person could be a picture of the user himself/herself laying in the user's own bed to further strengthen the association between the picture and the event of the user laying down in his/her own bed. Similarly, the sound signal 33 could be the voice from the user 26, the user's administrator 29 or parent so that the user is more likely to recognize the voice and be more comfortable about following the instruction or command of the sound signal 33.

Another important function is that the service is interactive so that the user must confirm that the event has been successfully completed. For example, after the user has taken the medicine or whatever the event may entail, the user must press a confirmation command 31 to trigger a confirmation signal 34 that is sent to the server 14 or to the administrator 29. A completed task symbol 35 may appear in the display 32 when the confirmation signal 34 has been successfully sent so the user knows there is no need to send another confirmation signal. If no confirmation signal 34 is sent within a certain time interval, a reminder may be sent to the user's mobile telephone. If the user 26 still fails to send back the confirmation signal 34, then the administrator 28 may trigger an alarm signal 36 to the telephone 16, the server 14 or to an alarm unit 37 to visit the user or otherwise help the user.

While the present invention has been described in accordance with preferred compositions and embodiments, it is to be understood that certain substitutions and alterations may be made thereto without departing from the spirit and scope of the following claims.

1. A method for reminding a user of an upcoming event, comprising:
providing a mobile communication device in communication with a server;
programming an event in a calendar and storing the calendar in the communication device;
associating a picture to describe the event;
using a clock device of the communication device to trigger the event;
automatically retrieving the picture from the communication device and displaying the picture;
requesting a user of the communication device to confirm that the event has been accomplished;
the user confirming completion of the event by activating a confirmation command to trigger a confirmation signal to be sent to the server or to an administrator until a completed task symbol is displayed on the mobile communication device when the confirmation signal has been successfully sent.

2. The method according to claim 1 wherein the method further comprises activating a checklist function to list several events.

3. The method according to claim 1 wherein the method further comprises activating a free text function from a menu.

4. The method according to claim 1 wherein the method further comprises taking pictures of familiar surroundings of the user and displaying the pictures on the communication device.

5. The method according to claim 1 wherein the method further comprises recording commands using voices familiar to the user to produce sound signals.

6. The method according to claim 1 wherein the method further comprises sending an alarm signal when a confirmation signal is not received.
